(19) United States
(12) Patent Application Publication
(10) Pub. No.: US 2014/0215250 A1
(43) Pub. Date: Jul. 31, 2014

(54) ELECTRONIC DEVICE AND POWER SAVING METHOD FOR ELECTRONIC DEVICE

(71) Applicant: HON HAI PRECISION INDUSTRY CO., LTD., New Taipei (TW)

(72) Inventors: YING-CYUAN CHEN, New Taipei (TW); YI-AN CHEN, New Taipei (TW); CHIN-SHUANG LIU, New Taipei (TW)

(73) Assignee: HON HAI PRECISION INDUSTRY CO., LTD., New Taipei (TW)

(21) Appl. No.: 14/159,547

(22) Filed: Jan. 21, 2014

(30) Foreign Application Priority Data
Jan. 28, 2013 (TW) 102103147

(51) Int. Cl. G06F 1/32

(52) U.S. Cl. CPC G06F 1/3231
USPC 713/323

(57) ABSTRACT

A power saving method for an electronic device includes the following steps. The electronic device detects if an input operation is received by the electronic device. The electronic device enters a monitor mode when no input operation is detected within a predefined time. The electronic device determines if a facial feature in front of the electronic device is present while in the monitor mode with a camera. The electronic device enters a power saving mode when no facial feature is detected.

### BACKGROUND

The disclosed embodiments relate generally to an electronic device and a power saving method for the electronic device.

### DESCRIPTION OF RELATED ART

Electronic devices, such as smart phones and notebook computers, have a set sleep mode time function. If the electronic device is left idle for a set length of time, the electronic device will enter a sleep mode to prevent power from being wasted. However, the electronic device can remain on for a period of time before entering sleep mode. In addition, if the electronic device needs to be used immediately after entering the sleep mode, the electronic device will be slow to turn on because power is automatically turned off when the set sleep mode time is reached. Thus, there is need for improvements within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of one embodiment of an electronic device.

FIG. 2 is one embodiment of a power saving method.

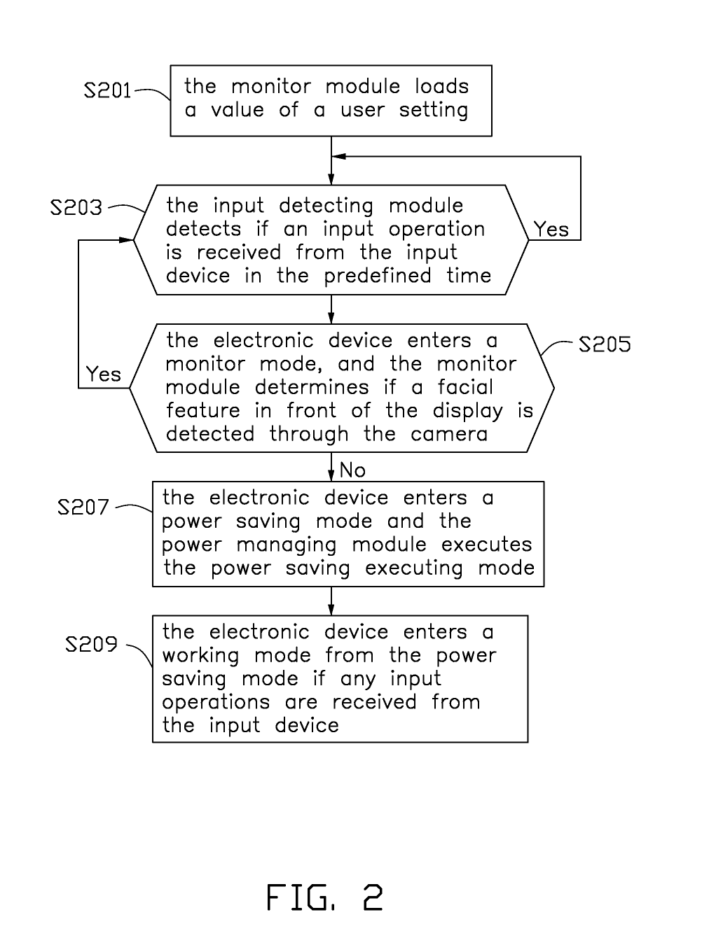

FIG. 3 is one embodiment of a user interface of a user setting.

FIG. 4 is one embodiment of a picture view.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

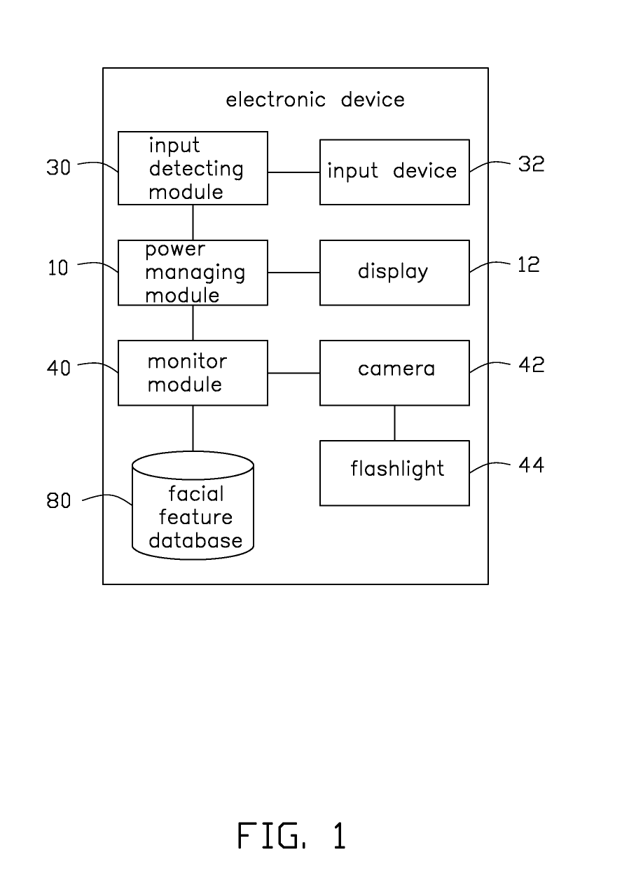

FIG. 1 is a block view of one embodiment of an electronic device 10. The electronic device can be a laptop computer, a smart phone, or a desktop computer. The electronic device includes an input detecting module 30, a power managing module 10, a monitor module 40, an input device 32, a display 12, a camera 42, and a flash 44. The display 12 is connected to the power managing module 10. The input device 32 is connected to the input detecting module 30. The camera 42 and the flash 44 are connected to the monitor module 40. The monitor module 40 is connected to a feature database, such as a facial feature database 80. The facial feature database 80 includes rules for facial features.

The power managing module 10 can be a processor, or a power controller combined with software. The power managing module 10 powers on or powers off the display 12 or an operation system of the electronic device.

The input detecting module 30 detects any input operation of the input device 32. The input device 32 can include a mouse, keyboard, touchpad, and microphone.

The monitor module 40 can detect if there are any facial features in front of the display 12 with the camera 42 to determine whether the electronic device is used. The facial feature includes facial physical features such as a shape of a face, mouth, nose, eyes, and geometrical relationship between the mouth and nose, mouth and eyes, or nose and eyes. The rules of the facial feature are stored in the facial feature database 80. The monitor module 40 can read the rules from the facial feature database 80. Some further features may be combined with the facial physical feature or geometrical relationship to detect if the electronic device is being used. For example, an open eye feature can determine that the user is not sleeping.

In one embodiment, the monitor module 40 may use red-eye effect to determine if there is a person in front of the electronic device. The red-eye effect in photography is the common appearance of red pupils in color photographs. It occurs when a photographic flash is very close to the camera lens in ambient low light. The effect appears in the eyes of humans, and of animals. The monitor module 40 can take a photo with the camera 42 with the flash 44 and detect a red-eye feature in the photo. In another embodiment, the monitor module 40 can take a first photo with the camera 42 with the flash 44 and take a second photo without the flash 44, and detect if a difference between the first photo and the second photo has a red-eye feature.

A power saving method for the electronic device includes the following steps.

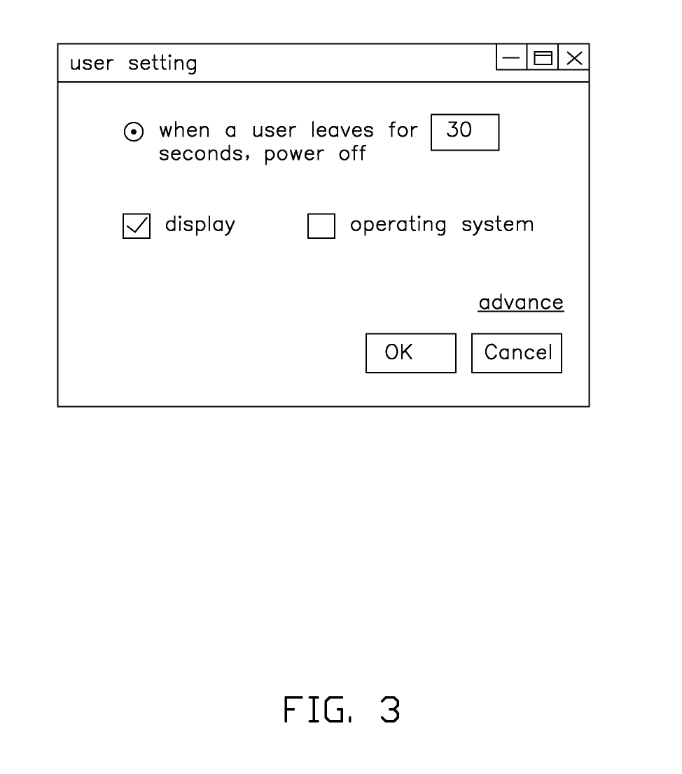

Step S201: the monitor module 40 loads a value of a user setting. The user setting includes a predetermine time, and an executing mode of power saving. FIG. 3 illustrates a user interface of the user setting.

Step S203: the input detecting module 30 detects if an input operation is received from the input device within the predefined time, if yes, the block S203 is repeated; if not, the method goes to S205.

Step S205: the electronic device enters a monitor mode, and the monitor module 40 determines if a facial feature in front of the display 12 is detected through the camera 42. If a facial feature is detected, the method goes back to step S203, and if no facial feature is detected, the method continues to step S207.

Step S207: the electronic device enters a power saving mode and the power managing module 10 executes the power saving executing mode, such as powering off the display or powering off the operating system of the electronic device.

Step S209: the electronic device enters a working mode from the power saving mode if any input operations are received from the input device 32, and the display and the operating system are powered on.

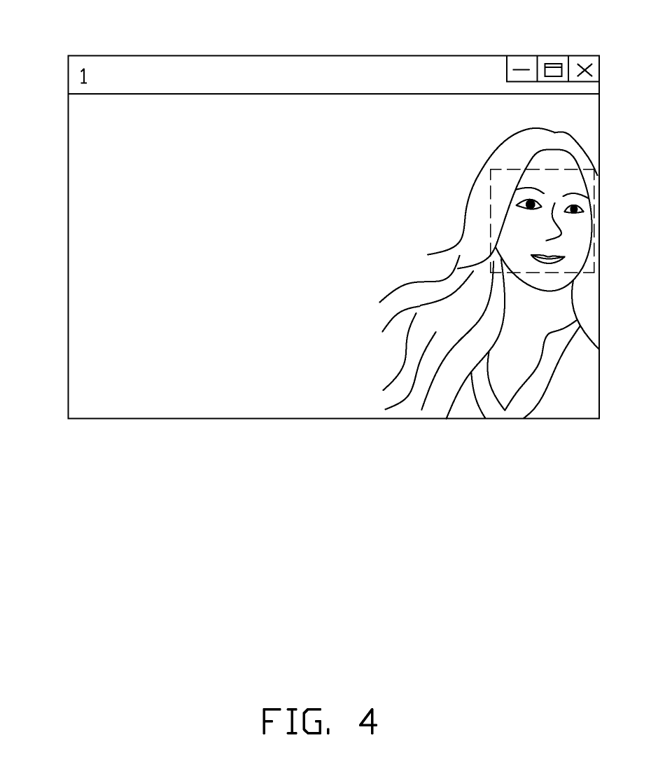

FIG. 4 illustrates a picture captured by the camera 42 and the monitor module 40 detects if there is a facial feature in front of the display. A capture distance of the camera can be less than 75 centimeters.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A power saving method for an electronic device, comprising:
detecting if an input operation is received by the electronic device;
entering a monitor mode when no input operation is detected within a predefined time;
determining if a facial feature in front of the electronic device is present while in the monitor mode with a camera; and
entering a power saving mode when no facial feature is detected.

2. The power saving method of claim 1, further comprising powering off a display of the electronic device in the power saving mode.

3. The power saving method of claim 2, further comprising powering off an operating system of the electronic device in the power saving mode.

4. The power saving method of claim 1, further entering a working mode from the power saving mode if any input operation is received.

5. The power saving method of claim 1, wherein the determining if the facial feature in front of the electronic device is present in the monitor mode further comprises determining if an ocular feature in front of the electronic device is present in the monitor mode.

6. The power saving method of claim 5, wherein the block of determining if an ocular feature in front of the electronic device is detected in the monitor mode further comprises taking a photo with a flash, and detecting if a red-eye feature is in the photo.

7. The power saving method of claim 5, wherein the block of determining if an ocular feature in front of the electronic device is present in the monitor mode further comprises taking a first photo with flash, taking a second photo without the flash, and determining if the first photo and the second photo has a difference in the red-eye feature.

8. An electronic device, comprising:
an input detecting module that detects if an input operation is received in the electronic device;
a display;
a camera;
a monitor module that determines if a facial feature in front of the display is present in the monitor mode with the camera; and
a power managing module;
wherein the power managing module is configured to enter a monitor mode when no input operation is detected within a predefined time, and is configured to enter a power saving mode from the monitor mode when no facial feature is detected.

9. The electronic device of claim 8, wherein the electronic device is configured to power off the display in the power saving mode.

10. The electronic device of claim 8, wherein the electronic device is configured to power off an operating system in the power saving mode.

11. The electronic device of claim 8, wherein the electronic device is further configured to enter a working mode from the power saving mode if any input operations are received.

12. The electronic device of claim 8, wherein the electronic device is further configured to determine if an ocular feature in front of the electronic device is present in the monitor mode.

13. The electronic device of claim 12, further comprising a flash, wherein the monitor module is configured to take a photo with the camera with flash, and detect if a red-eye feature is present in the photo.

14. The electronic device of claim 12, further comprising a flash, wherein the monitor module is configured to take a first photo with the flash, take a second photo without the flash, and determine if a difference between the first photo and the second photo has a different red-eye feature.
